(19) United States
(12) Patent Application Publication
(10) Pub. No.: US 2025/0040550 A1
(43) Pub. Date: Feb. 6, 2025

(54) INSECTICIDE COMPOSITION, FORMULATIONS AND PROCESS FOR PREPARATION THEREOF

(71) Applicant: RALLIS INDIA LIMITED, Wadala, Mumbai, Maharashtra (IN)

(72) Inventors: Mallikarjunappa SIDDAPPA, Hegganahalli, Bangalore, Karnataka (IN); Kendappa GOWDRA NANJAPPA, Hegganahalli, Bangalore, Karnataka (IN); Karankumar Babubhai PATEL, Hegganahalli, Bangalore, Karnataka (IN); Rupak PAUL, Hegganahalli, Bangalore, Karnataka (IN); Vijay Kumar REDDY, Hegganahalli, Bangalore, Karnataka (IN)

(21) Appl. No.: 18/714,181

(22) PCT Filed: Nov. 29, 2022
(86) PCT No.: PCT/IB2022/061510

§ 371 Date: May 29, 2024

(30) Foreign Application Priority Data
Nov. 29, 2021 (IN) 202121055229

(51) Int. Cl. A01N 43/56; A01N 25/04; A01N 47/40; A01N 53/00; A01P 7/04

(52) U.S. Cl. CPC A01N 43/56; A01N 25/04; A01N 47/40; A01N 53/00; A01P 7/04

(57) ABSTRACT

The present disclosure relates to a composition comprising active ingredients chlorantraniliprole, acetamiprid and lambda-cyhalothrin. Particularly, the present disclosure provides an insecticide composition comprising three active ingredients chlorantraniliprole, acetamiprid and lambda-cyhalothrin in combination with one or more agrochemically acceptable excipient(s). The present disclosure further provides formulations comprising three active ingredients chlorantraniliprole, acetamiprid and lambda-cyhalothrin and one or more agrochemically acceptable excipient(s) and process for preparation thereof.

### FIELD OF THE INVENTION

The present invention relates to the technical field of insecticides. In particular the present disclosure relates to an insecticide composition, formulations and a process for preparing the same.

### BACKGROUND OF THE INVENTION

The background description includes information that may be useful in understanding the present invention. It is not an admission that any of the information provided herein is prior art or relevant to the presently claimed invention, or that any publication specifically or implicitly referenced is prior art.

Pest infestations pose significant adverse effect on economically important agricultural crops such as cotton, brinjal, okra, tomato, chilli, soybean, chick pea and cabbage. Particularly, cotton an important fiber and cash crops and chilli a spice crop, which plays a dominant role in the industrial and agricultural economy are infested by major insects such as sucking insects, which includes thrips, aphids, whiteflies and jassids and caterpillars such as helicoverpa, spodoptera and pink bollworm.

To address problems associated with infestation with such insects, researchers are trying to produce an extensive variety of active ingredients and active ingredients formulations effective in controlling insects. Chemical insecticides of many types have been disclosed in the art and a large number of such chemical insecticides are in commercial use. In crop protection, it is desirable in principle to increase specificity and reliability of action of insecticidal active ingredients.

Imidacloprid, chlorantraniliprole, ethion, fenpropathrin, fipronil, dimethoate, lambda cyhalothrin, methomyl, spinosad, thiacloprid, acetamiprid, chlorantraniliprole, diafenthiuron, thiamethoxam, novaluron, lufenuron are compounds independently known in the art for their insecticidal potency. They are disclosed in ‘The Pesticide Manual’ 15^{th} Edition, published 2009 by the British Crop Protection Council, and are also commercially available.

It is known that to seek and obtain registration for a new insecticide compound, including its proposed use rate, is very expensive and time-consuming process. Approval data required must not only include evidence of efficacy at the application rates proposed but also safety of insecticide when applied at the recommended level, also information about the recommended level of insecticide that may be applied per unit of area needs to be provided in view of pressure from governmental, as well as for economic and environmental reasons.

It is a common knowledge that with the use of a single insecticide over a period, the insects develop resistance, rendering the particular insecticide ineffective for use against a specific insect. Thus, on one hand even more stringent conditions are being placed on the type and use rate of insecticide, while on the other hand approved insecticides available in the art are becoming less and less effective over time in insect pests.

Due to such reasons including the lengthy and cost intensive process, resistance to single insecticide, combinations of known and approved insecticides are attempted.

Two-way combinations of acetamiprid with diafenthiuron; and chlorantraniliprole with thiamethoxam or lambda cyhalothrin are known in the art and are in commercial use.

However, certain insect pests are becoming increasingly resistant to even a number of most widely used insecticides compositions with common combination of two ingredients available in the art. Hence, such combinations are also found to be ineffective in controlling insects in effective manner. Other problem with the combinations and formulations containing such two active ingredients can be lack of stability and in certain cases increased toxicity for human, and animals.

Thus, there still remains an unmet great need in the art for efficacious, insecticide composition and formulation comprising combination of more than two active ingredients for example combination of three active ingredients having different mode of action, showing one or more of advantage such as stability, synergistic effect, faster onset of insecticide action, a broad-spectrum and longer-lasting action, reduced dosage of active ingredients, reduced application rate of the insecticide thereby rendering such combination environmentally safe, and reduce or delay the development of resistance in pests, which is necessary to obtain acceptable insect pest control and a process for preparing such insecticide composition or formulation comprising the same.

### SUMMARY OF THE INVENTION

The present invention provides a composition comprising three active insecticidal ingredients.

In an aspect, the present disclosure provides an insecticide composition comprising chlorantraniliprole, acetamiprid and lambda-cyhalothrin.

In an aspect, the present disclosure provides an insecticide formulation comprising chlorantraniliprole, acetamiprid and lambda-cyhalothrin.

In an aspect, the present disclosure provides an insecticide formulation comprising the active ingredients chlorantraniliprole, acetamiprid, lambda-cyhalothrin and one or more agrochemically acceptable excipient(s).

In one aspect, the insecticide composition comprises chlorantraniliprole in an amount of from about 0.1% to about 30% w/w, acetamiprid in an amount of from about 0.1% to about 25% w/w and lambda-cyhalothrin in an amount of from about 0.1% to about 25% w/w of the composition.

In one aspect, the insecticide formulation comprises chlorantraniliprole in an amount of from about 0.1% to about 30% w/w, acetamiprid in an amount of from about 0.1% to about 25% w/w and lambda-cyhalothrin in an amount of from about 0.1% to about 25% w/w of the formulation.

In an aspect, the present disclosure provides a formulation comprising the insecticide composition of the present invention, the formulation is selected from water-dispersible granule (WDG), a water-soluble granule (SG), a wettable powder (WP), a water-dispersible powder (WDP), a water-soluble powder (SP), a granule (GR), an encapsulated granule (CG), a fine granule (FG), a macrogranule (GG), a microgranule (MG), a suspension concentrate (SC), a water-soluble concentrate (SL), an emulsifiable concentrate (EC), an emulsion (EW), a micro-emulsion (ME), a flowable suspension (FS), a suspoemulsion (SE), ZC formulation (ZC), soil applied granules (SAG), dustable powder (DP), a gel, a water-dispersible tablet (WT), an oil-dispersion (OD), a dispersible concentrate (DC) or a microencapsulated suspension (CS).

In one aspect, the present disclosure provides an oil-dispersion (OD) formulation comprising the insecticide composition containing three active ingredients in accordance with the present disclosure.

In an aspect, the present disclosure provides a process for preparing the insecticide composition or formulation comprising three active ingredients. The process comprises mixing chlorantraniliprole, acetamiprid and lambda-cyhalothrin.

In one specific aspect, the present disclosure provides a process for preparing oil-dispersion (OD) formulation.

In one aspect, the process for preparing oil-dispersion (OD) formulation comprises,
a) mixing one or more excipient(s) along with an oil medium to obtain a mixture;
b) adding chlorantraniliprole, acetamiprid and lambda-cyhalothrin to the mixture and continuing to mix to obtain a slurry;
c) subjecting the slurry for particle size reduction by passing the slurry through a mill to obtain a milled slurry; and
d) adding a rheology modifier to the milled slurry and continuing to mix to obtain a homogeneous oil dispersion (OD).

Various objects, features, aspects and advantages of the inventive subject matter will become more apparent from the following detailed description of preferred embodiments.

### DETAILED DESCRIPTION OF THE INVENTION

The following is a detailed description of embodiments of the present disclosure. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims.

Unless the context requires otherwise, throughout the specification which follow, the word “comprise” and variations thereof, such as, “comprises” and “comprising” are to be construed in an open, inclusive sense that is as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

In some embodiments, the numbers expressing quantities of ingredients, properties such as concentration, process conditions, and so forth, used to describe and claim certain embodiments of the invention are to be understood as being modified in some instances by the term “about.” Accordingly, in some embodiments, the numerical parameters set forth in the written description are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable.

The recitation of ranges of values herein is merely intended to serve as a shorthand method of referring individually to each separate value falling within the range. Unless otherwise indicated herein, each individual value is incorporated into the specification as if it were individually recited herein.

All methods described herein is performed in suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

The headings and abstract of the invention provided herein are for convenience only and do not interpret the scope or meaning of the embodiments.

The following discussion provides many example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

The present invention does not use any ‘biological materials’ that is the materials which are capable of reproducing itself or being reproduced in a biological system.

The present disclosure relates to an insecticide composition comprising three active ingredients, formulations thereof and process for preparing the same.

In one embodiment, the present disclosure provides a composition comprising chlorantraniliprole, acetamiprid and lambda-cyhalothrin.

In another embodiment, the present disclosure provides a formulation comprising chlorantraniliprole, acetamiprid and lambda-cyhalothrin.

Chlorantraniliprole chemically known as 3-bromo-N-[4-chloro-2-methyl-6-[(methylamino) carbonyl]phenyl]-1-(3-chloro-2-pyridinyl)-1H-pyrazole-5-carboxamide is a diamide insecticide and pyridylpyrazole insecticide. It is a systemic insecticide and it acts by activating the ryanodine receptors in the calcium release channel causing muscle contraction and paralysis in the insects.

Acetamiprid chemically known as (1E)-N-[(6-chloro-3-pyridinyl)methyl]-N′-cyano-N-methylethanimidamide is a pyridylmethylamine, neonicotinoid insecticide. It is a systemic insecticide and it acts by binding to the acetylcholine site on nicotinoyl acetylcholine receptors (nAChRs), causing a range of symptoms from hyperexcitation to lethargy and paralysis in the insects.

Lambda-cyhalothrin chemically known as (R)-cyano (3-phenoxyphenyl)methyl (1S,3S)-rel-3-[(1Z)-2-chloro-3,3,3-trifluoro-1-propen-1-yl]-2,2-dimethylcyclopropanecarboxylate is a pyrethroid ester insecticide. It is a contact insecticide and it acts by disrupting the gating mechanism of sodium channels that are involved in the generation and conduction of nerve impulses, causing rapid paralysis and death of the insects.

The composition in accordance with the present disclosure can comprise active ingredients chlorantraniliprole, acetamiprid and lambda-cyhalothrin in a wide range of amounts effective for example to treat desired crops infested by different pests.

In certain embodiments, the composition or formulation comprises chlorantraniliprole, acetamiprid and lambda-cyhalothrin in total amount ranging from about 0.1% to about 60% by weight of the composition or formulation.

In certain embodiments, the composition comprises, by weight, from about 0.1% to about 30% w/w of chlorantraniliprole, from about 0.1% to about 25% w/w of acetamiprid and from about 0.1% to about 25% w/w of lambda-cyhalothrin.

In certain embodiments, the formulation comprises, by weight, from about 0.1% to about 30% w/w of chlorantraniliprole, from about 0.1% to about 25% w/w of acetamiprid and from about 0.1% to about 25% w/w of lambda-cyhalothrin.

In an embodiment, the present disclosure provides composition comprising active ingredient chlorantraniliprole, acetamiprid and lambda-cyhalothrin in combination with one or more agrochemically acceptable excipient(s).

In an embodiment, the present disclosure provides formulation comprising active ingredient chlorantraniliprole, acetamiprid and lambda-cyhalothrin in combination with one or more agrochemically acceptable excipient(s).

The agrochemically acceptable excipient or excipient known in the art of agrochemicals can be an inactive excipient.

Suitable excipients will depend upon such factors as the type of formulation and the manner of the end use of the formulation, and will be known to a person skilled in the art.

In some embodiments, the excipients can be selected from the group comprising of but not limited to an emulsifier, a dispersing agent, a stabilizing agent, a wetting agent, a spreading agent, an anti-foaming agent, a rheology modifier, a solvent, a pH modifier, a co-solvent, an inert carrier, an anti-caking agent, an antioxidant, a biocide, an anti-freezing agent, an anti crystalline agent or combination thereof.

Suitable emulsifier for use in the composition includes all substances which normally can be used for this purpose in agrochemical compositions. Examples of the excipient include substances which can be ionic or non-ionic emulsifier or surfactant.

The ionic substances can be selected from cationic, or anionic or combinations thereof. The ionic emulsifier or surfactant can be selected from the group comprising of but not limited to calcium salt of alkylaryl sulfonates, ethoxylated and/or propoxylated di- or tri-styrylphenol phosphate, ethoxylated and/or propoxylated di- or tri-styrylphenol sulfate, phenyl sulfonate, alkynaphtalenesulphonate ethoxylated and/or propoxylated alcohol phosphate ester, ethoxylated and/or propoxylated alkylaryl phosphate ester, suphosuccinate, salts of polyacrylic acids, salts of lignosulphonic acid, salts of phenylsulphonic or naphthalenesulphonic acids, polycondensates of ethylene oxide with fatty alcohols or with fatty acids or with fatty amines, substituted phenols, especially alkylphenols phosphoric esters of polyethoxylated phenols or alcohols or polycarboxylate or mixtures thereof.

The non-ionic emulsifier or surfactant can be selected from the group comprising of but not limited to alkoxylated alcohols, ethoxylated alcohols, ethoxylated propoxylated alcohols, alkylphenolethoxylates, alkoxylated tristyrylphenols, tristyryphenol ethoxylate, alkoxylated tributylphenols, alkylaminethoxylates, ethoxylated propoxylated polyaryl phenol, ethoxylated poly adducts of ethylene oxide and propylene oxide, ethoxylated fatty acids, sorbitan esters and their ethoxylates, sorbitol esters, propylene glycol esters of fatty acids and polyglycerol esters, ethoxylated ricinoleic acid triglycerides, castor oil ethoxylate or mixtures thereof.

The emulsifier can be present in an amount ranging from about 0.1% to about 15% w/w of the composition or formulation.

The dispersing agent can be selected from but not limiting to lignosulphonates, phenyl naphthalene sulphonates, polyaromatic sulfonates, sodium alkyl aryl sulfonates, maleic anhydride copolymers, phosphate esters, condensation products of aryl/alkyl sulphonic acids and formaldehyde, addition products of ethylene oxide and fatty acid esters, sulfonates of condensed naphthalene, lignin derivatives, naphthalene formaldehyde condensates, polycarboxylates, sodium alkyl benzene sulfonates, alkali earth metal salt of alkylbenzene sulfonate, calcium dodecylbenzene sulfonate, salts of sulfonated naphthalene, polystyrenated acrylated co-polymer, ammonium salts of sulfonated naphthalene, salts of polyacrylic acids, salts of phenol sulfonic acids, random co-polymer of alcoxylated polyethylene glycol or mixtures thereof.

The dispersing agent can be present in an amount ranging from about 0.01% to about 12.0% w/w of the composition or formulation.

The stabilizing agent can be selected without limitation from modified hydrophobic silica, colloidal silica, precipitated silica, hydrophobic silica powder, dimethyldichlorosilane-treated fumed silica, gamma butyrolactone, butylated hydroxyl toluene and its derivatives, epichlorhydrin, quinone derivatives, hydrazine hydrates and its derivatives, glycols or its derivatives, polyvinylpyrrolidone (PVP) or mixtures thereof.

The stabilizing agent can be present in an amount ranging from about 0.01% to about 5% w/w of the composition or formulation.

The wetting agent can be selected from without limitation alkyl phenol ethoxylate, fatty oil ethoxylate, phenyl naphthalene sulphonates, alkyl naphthalene sulfonates, sodium alkyl naphthalene sulfonate, sodium salt of sulfonated alkyl carboxylate, polyoxyalkylated ethyl phenols, polyoxyethoxylated fatty alcohols, polyoxyethoxylated fatty amines, lignin derivatives, alkane sulfonates, alpha olefin sulfonates, alkylbenzene sulfonates, salts of polycarboxylic acids, salts of esters of sulfosuccinic acid, octyl phenol ether sulphate, anionic phosphate esters, disodium laureth sulfosuccinate, diisodecyl sodium sulfosuccinate, alkylbenzenesulfonates, alkylpolyglycol ether sulfonates, alkyl ether phosphates, alkyl ether sulfates and alkyl sulfosuccinic monoesters, dioctyl sulfosuccinate sodium salt or mixtures thereof.

The wetting agent can be present in an amount ranging from about 0.01% to 9% w/w of the composition or formulation.

The spreading agent can be selected from the group comprising of polyoxyethylene alkyl ether, trisiloxane ethoxylate, polysorbates, ethoxylated tristyrylphenol phosphate, sodium lauryl sulphate, sodium methyl oleoyl taurate, tridecyl alcohol ethoxylate or mixtures thereof.

The spreading agent can be present in an amount ranging from about 0.1% to about 20% w/w of the composition or formulation.

The anti-foaming agent can be selected from the group comprising perfluroalkylphosphonic acids, polydimethyl siloxane or mixtures thereof.

The anti-foaming agent can be present in an amount ranging from about 0.01% to about 5% w/w of the composition or formulation.

The rheology modifier can be selected without limitation from fume silica, bentonite, diatomaceous earth, montmorillonite, attapulgites, hydroxymethyl cellulose, xanthan gum, polyvinyl alcohol, benton, thickening silica, hydrated clay minerals, magnesium aluminium silicates, organic derivative of hectorite clay, hydrophobic fumed silica or mixtures thereof.

The rheology modifier can be present in an amount ranging from about 0.01% to about 12% w/w of the composition or formulation.

Suitable solvents for use in the composition can be selected from all customary organic solvents which dissolve one or more of the active ingredients of the insecticide composition. Suitable aqueous and non aqueous organic solvents for the compounds chlorantraniliprole, acetamiprid and lambda-cyhalothrin are known in the art. Preferred solvents can be selected from but not limited to, deionized (DI) water, N-alkyl pyrrolidone, N-methyl-2-pyrrolidone, dimethylformamide (DMF), dimethylsulfoxide (DMSO), oil medium selected from the group comprising, esterified fatty acids selected from methyl ester of triglycerides containing C₁₂-C₂₂ saturated and unsaturated fatty acids, ethyl ester of triglycerides containing C₁₂-C₂₂ saturated and unsaturated fatty acids such as methyl soyate (UNITOP-MSO), ethyl soyate, rapeseed methyl ester, rapeseed ethyl ester, bio-diesels, tall oil, Rhodiasolv Adma 10 (N,N-Dimethyldecanamide), Rhodiasolv® match 111 (blend of solvents), Rhodiasolve Green 25 (diisobutyl ester), Rhodiasolv® polar clean (Methyl (5-(dimethylamino)-2-methyl-5-oxopentanoate) or mixtures thereof.

The solvent can be present in an amount ranging from about 1.0% to about 95% w/w of the composition or formulation.

The pH modifier can be selected without limitation from sodium silicate, potassium silicate, magnesium silicate, manganese silicate, sodium pyrophosphate, sodium acetate, sodium oxalate, sodium carbonate, sodium bicarbonate, sodium bentonite, sodium acetate, attapulgite, diatomaceous earth, sodium zeolite, trisodium phosphate, trisodium citrate, magnesium carbonate, magnesium sulphate, monoethanol amine, triethanol amine, triethylamine, dibasic esters selected from dimethyl succinate, dimethyl glutarate, dimethyl adipate, ortho phosphoric acid, oxalic acid, citric acid, hydrochloric acid or mixtures thereof.

The pH modifier can be present in an amount ranging from about 0% to about 5% w/w of the composition or formulation.

The co-solvents can be selected from the group comprising of solvent naphtha (heavy, medium, light), turpentine oil, xylene, toluene, 1,2,4-trimethylbenzene (pseudocumene) or mixtures thereof.

The co-solvent can be present in an amount ranging from about 0% to about 35% w/w of the composition or formulation.

The inert carriers can be selected from kaolin, china clay, alumina, talc, chalk, quartz, attapulgite, montmorillonite, crushed and fractionated natural minerals such as calcite, marble, pumice, precipitated silica, sepiolite, bentonite, river sand, zeolites, starch, sand, talc, quartz, dolomite, diatomaceous earthor synthetic ground minerals such as highly dispersed silicic acid, aluminium oxide, silicates, calcium phosphates, calcium hydrogen phosphates or mixtures thereof.

The inert carrier can be present in an amount ranging from about 0% to about 90% w/w of the composition or formulation.

The anti-caking agent can be selected from but not limiting to kaolin clay, precipitate silica, colloidal silica, fumed silica, talc, gypsum, silicates, calcium carbonate, magnesium carbonate, magnesium sulfate or mixtures thereof.

The anti-caking agent can be present in an amount ranging from about 0% to about 5% w/w of the composition or formulation.

Suitable antioxidants are all substances which normally be used for this purpose in agrochemical compositions, as is known in the art. Preferred antioxidant is butylated hydroxytoluene.

The antioxidant can be present in an amount from about 0% to about 5% w/w of the composition or formulation.

The biocide can be selected from 1,2-benzisothiazolin-3-one, formaldehyde or mixtures thereof.

The biocide can be present in an amount from about 0% to about 1% w/w of the composition or formulation.

Suitable anti-freezing agents include ethylene glycol, propylene glycol, glycerine, urea or mixtures thereof.

The anti-freezing agent can be present in an amount of from about 0% to about 12% w/w of the composition or formulation.

The anti-crystalline agent can be selected without limitation from vinyl pyrrolidone polymer, polyvinyl alcohol, sodium polyacrylate co-polymer or mixtures thereof.

The anti-crystalline agent can be present in an amount ranging from about 0% to about 10% w/w of the composition or formulation.

According to certain embodiments of the present disclosure, the insecticide composition comprising chlorantraniliprole, acetamiprid and lambda-cyhalothrin can be provided as formulation which is then used in a conventional way by diluting with water or prepared as tank mixes by jointly diluting separately formulated or partially separately formulated active ingredients with water or with aqueous solutions.

In various embodiments, the insecticide composition comprising the combination of chlorantraniliprole, acetamiprid and lambda-cyhalothrin can be provided as formulation in liquid or solid form.

In certain embodiments, the formulation comprising the combination of chlorantraniliprole, acetamiprid and lambda-cyhalothrin can be selected from without limitation a water-dispersible granule (WDG), a water-soluble granule (SG), a wettable powder (WP), a water-dispersible powder (WDP), a water-soluble powder (SP), a granule (GR), an encapsulated granule (CG), a fine granule (FG), a macrogranule (GG), a microgranule (MG), a suspension concentrate (SC), a water-soluble concentrate (SL), an emulsifiable concentrate (EC), an emulsion (EW), a micro-emulsion (ME), a flowable suspension (FS), a suspoemulsion (SE), ZC formulation (ZC), soil applied granules (SAG), dustable powder (DP), a gel, a water-dispersible tablet (WT), an oil-dispersion (OD), a dispersible concentrate (DC) or a microencapsulated suspension (CS).

In a preferred embodiment, the insecticide composition comprising the combination of chlorantraniliprole, acetamiprid and lambda-cyhalothrin is formulated as an oil-dispersion (OD).

In one embodiment, the oil-dispersion (OD) formulation comprises:
(a) about 0.1% to about 30.0% chlorantraniliprole by weight of the formulation;
(b) about 0.1% to about 25.0% acetamiprid by weight of the formulation;
(c) about 0.1% to about 25.0% lambda-cyhalothrin by weight of the formulation;
(d) about 0.1% to about 15.0% emulsifier by weight of the formulation;
(c) about 0.01% to about 12.0% dispersing agent by weight of the formulation;
(f) about 0.01% to about 5.0% stabilizing agent by weight of the formulation;
(g) about 0.01% to about 9.0% wetting agent by weight of the formulation;
(h) about 0.1% to about 20.0% spreading agent by weight of the formulation;
(i) about 0.01% to about 5.0% antifoaming agent by weight of the formulation;
(j) about 0.01% to about 12.0% rheology modifier by weight of the formulation; and
(k) about 1.0% to about 95.0% solvent by weight of the formulation.

In another embodiment, the oil-dispersion (OD) formulation comprises:
a) about 0.1% to about 30.0% chlorantraniliprole by weight of the formulation
b) about 0.1% to about 25.0% acetamiprid by weight of the formulation;
c) about 0.1% to about 25.0% lambda-cyhalothrin by weight of the formulation;
d) about 0.1% to about 15.0% emulsifier by weight of the formulation selected from the group comprising of ethoxylated propoxylated alcohols, alkylphenolethoxylates, alkoxylated tristyrylphenols, ethoxylated propoxylated polyaryl phenol, ethoxylated fatty acids, ethoxylated ricinoleic acid triglycerides, castor oil ethoxylate or mixtures thereof;
c) about 0.01% to about 12.0% dispersing agent by weight of the formulation selected from the group comprising of naphthalene formaldehyde condensates, polycarboxylates, calcium dodecylbenzene sulfonate, polystyrenated acrylated co-polymer, salts of phenol sulfonic acids, random co-polymer of alcoxylated polyethylene glycol or mixtures thereof;
f) about 0.01% to about 5.0% stabilizing agent by weight of the formulation selected from the group comprising of precipitated silica, polyvinylpyrrolidone (PVP) or mixtures thereof;
g) about 0.01% to about 9.0% wetting agent by weight of the formulation selected from the group comprising of sodium alkyl naphthalene sulfonate, alpha olefin sulfonates, disodium laureth sulfosuccinate, diisodecyl sodium sulfosuccinate, alkyl sulfosuccinic monoesters, dioctyl sulfosuccinate sodium salt or mixtures thereof;
h) about 0.1% to about 20.0% spreading agent by weight of the formulation selected from the group comprising of polyoxyethylene alkyl ether, trisiloxane ethoxylate, polysorbates, sodium lauryl sulphate, tridecyl alcohol ethoxylate or mixtures thereof;
i) about 0.01% to about 5.0% antifoaming agent by weight of the formulation selected from the group comprising perfluroalkylphosphonic acids, polydimethyl siloxane or mixtures thereof;
j) about 0.01% to about 12.0% rheology modifier by weight of the formulation selected from the group comprising of fume silica, bentonite, hydroxymethyl cellulose, xanthan gum, thickening silica, hydrated clay minerals, magnesium aluminium silicates, organic derivative of hectorite clay, hydrophobic fumed silica or mixture thereof; and
k) about 1.0% to about 95.0% solvent by weight of the formulation selected from the group comprising of N-alkyl-pyrrolidone, oil medium selected from the group comprising, esterified fatty acids selected from methyl ester of triglycerides containing C₁₂-C₂₂ saturated and unsaturated fatty acids, ethyl ester of triglycerides containing C₁₂-C₂₂ saturated and unsaturated fatty acids such as methyl soyate, ethyl soyate, rapeseed methyl ester, rapeseed ethyl ester or mixtures thereof.

The oil dispersion (OD) is a stable suspension of active ingredients in an organic fluid, which may contain other dissolved active ingredients intended for dilution with water before use.

The present disclosure provides a process for preparing the insecticide composition or formulation described herein. The insecticide composition or formulation can be prepared by mixing the respective active ingredients and, if appropriate, one or more excipients known in the art of agrochemicals.

In another embodiment, the present disclosure further provides a process for preparing oil-dispersion (OD) formulation comprising:
a) mixing one or more excipient(s) along with an oil medium to obtain a mixture;
b) adding chlorantraniliprole, acetamiprid and lambda-cyhalothrin to the mixture and continuing to mix to obtain a slurry;
c) subjecting the slurry for particle size reduction by passing the slurry through a mill to obtain a milled slurry; and
d) adding a rheology modifier to the milled slurry and continuing to mix to obtain a homogeneous oil dispersion (OD).

In one embodiment, the mill for particle size reduction is a jacketed mill with chilled water circulation.

In one embodiment, the excipients are selected from the group comprising of an emulsifier, a dispersing agent, a stabilizing agent, a wetting agent, a spreading agent, an anti-foaming agent, a rheology modifier, a solvent or combination thereof.

The insecticide composition can be applied to the insects in a variety of ways, at various application timings and at various concentrations.

In one embodiment, the insecticide composition of the present disclosure is applied to the insects by foliar application. The application of the insecticide composition is done on the crops from vegetative phase to reproductive phase. The total application rate of the composition or formulation provided in accordance with the present disclosure comprising chlorantraniliprole, acetamiprid and lambda-cyhalothrin vary over a wide range, for example from 1 to 500 g/ml per hectare (g/ml/ha).

In one embodiment, the composition or formulation provided in accordance with the present disclosure can be applied at the application rate ranging from 450 to 500 g/ml per hectare (g/ml/ha).

The insecticide composition or formulation thereof can be applied in a single treatment or in several treatments (sequential application).

The insecticide composition or formulation thereof according to the present disclosure can be advantageously applied for the protection of crops such as cotton, brinjal, okra, tomato, chilli, soybean, chick pea and cabbage.

In specific embodiments, the insecticide composition or formulation thereof in accordance with the present disclosure can be applied for protection of cotton and chilli crops.

The insecticide composition comprising combination of chlorantraniliprole, acetamiprid with lambda-cyhalothrin can control the broad spectrum of insects of different orders that is order lepidoptera and order homoptera. The insecticide composition of the present disclosure can control insects of order lepidoptera including caterpillars such as helicoverpa, spodoptera, pink bollworm; and of order homoptera which include sucking pests such as thrips, jassids, aphids, and whiteflies, by one time application.

The synergistic effects of the insecticide composition comprising combination of chlorantraniliprole, acetamiprid and lambda-cyhalothrin as against the use of each active ingredient alone, include one or more of advantages such as a reduction in application rate of individual active ingredients, a faster onset of insecticidal action, a longer-lasting action, better control of broad spectrum of insects with only one or a few applications, and a broadening of possible application period. It was an unexpected finding that the dose of each active ingredient markedly reduced, when all the three compounds are comprised in combination in a single composition, while maintaining a high level of insecticidal efficacy. Especially, the use of the combination of chlorantraniliprole, acetamiprid and lambda-cyhalothrin has the potential to control insects at a low application rate, in particular at a rate of application at which the individual active ingredients alone are less efficacious and still controlling a wider variety of insect pests compared to the compounds when used alone for the treatment of infested site of desired crop. The composition comprising the three aforementioned active ingredients unexpectedly also is capable of showing speed/onset of action faster than that which would have been predicted from the speed/onset of action of each ingredient used individually and in combination of two ingredients.

### EXAMPLES

The present disclosure is further explained in the form of following examples. However, it is to be understood that the following examples are merely illustrative and are not to be taken as limiting to the invention. Various changes and modifications to the disclosed embodiments will be apparent to those skilled in the art. Such changes and modifications may be made without departing from the disclosure of the present application.

### Examples 1-3

Oil-Dispersion (OD) Formulations in Accordance with the Present Invention

### I. Preparation of the OD Formulations:

### 1. Composition:

As per some specific exemplary embodiments, oil-dispersible (OD) formulations were prepared with compositions as per Table 1:

TABLE 1
Composition for oil-dispersion (OD) formulations
of the present invention.

| | Example 1 | Example 2 | Example 3 |
|---|---|---|---|
| Ingredients | % w/w | % w/w | % w/w |
| Chlorantraniliprole | 6.0 | 10.0 | 18.0 |
| Acetamiprid | 4.0 | 5.0 | 12.0 |
| Lambda-cyhalothrin | 5.0 | 7.5 | 10.0 |
| Tergitol ECO-36 | 5.0 | 4.5 | 5.5 |
| Random co-polymer of alcoxylated | 2.0 | 2.7 | 3.4 |
| polyethylene glycol | | | |
| Polyvinylpyrrolidone (PVP) | 0.5 | 0.6 | 0.8 |
| Dioctyl sulfosuccinate sodium salt | 5.0 | 6.5 | 7.0 |
| Tridecyl Alcohol ethoxylate | 5.0 | 6.0 | 10.0 |
| Polydimethyl siloxane | 0.5 | 0.5 | 0.5 |
| Hydrophobic fumed silica | 6.0 | 4.3 | 3.4 |
| Organic derivative of hectorite clay | 1.0 | 1.5 | 2.1 |
| Methyl soyate (UNITOP - MSO) | Q.S. | Q.S. | Q.S. |
| Total | 100.00 | 100.00 | 100.00 |

### 2. Process for Preparing the Oil-Dispersion (OD) Formulation:

An oil medium methyl soyate (UNITOP-MSO) along with other constituents namely ethoxylated ricinoleic acid triglycerides (Tergitol ECO-36), random co-polymer of alcoxylated polyethylene glycol, polyvinylpyrrolidone (PVP), dioctylsulfosuccinate sodium salt, tridecylalcohol ethoxylate, and polydimethyl siloxane as mentioned in Table 1 for Examples 1 to 3 were added into the clean pre mixing vessel fitted with the homogenizer and all the ingredients were mixed for 15 minutes with the homogenizer to obtain a mixture. The active ingredients, chlorantraniliprole, acetamiprid and lambda-cyhalothrin were added to the obtained mixture and continued to mix for 1 to 2 hours with the homogenizer to obtain a slurry. The slurry was passed through jacketed bead mill with chilled water circulation for particle size reduction to obtain a milled slurry of desirable particle size of d (90)<12 microns. The milled slurry was collected into post mixing vessel fitted with the stirrer. Rheology modifiers hydrophobic fumed silica and organic derivative of hectorite clay as mentioned in Table 1 for Examples 1 to 3 were added into the post mixing vessel and continued to mix for 4 to 6 hours to obtain homogeneous oil dispersion (OD).

Without bound by any theory it, is believed that methyl soyate (UNITOP-MSO) when used as a solvent, both the active ingredients lambda-cyhalothrin having a low melting point and acetamiprid having high water solubility remain stable; further, the methyl soyate being an oil medium is believed to rupture the outer covering layer of the insects (insect cuticle) and help the active ingredients chlorantraniliprole, acetamiprid and lambda-cyhalothrin to penetrate easily into the insect cuticle thereby improving the performance of the active ingredients; thus, methyl soyate acts as both solvent in which active ingredients remain stable and as an integral adjuvant which helps in easy and fast penetration of active ingredients thereby avoiding the addition of external adjuvant before spraying the OD formulation of the present invention.

### II. Accelerated Storage Test (Stability Study):

According to the FAO/WHO manual, the “accelerated storage test” is considered as an indicative of product stability. That is, accelerated storage test data provides an indication that the product is stable for at least two years at ambient temperature. Further, the FAO/WHO manual indicates storage at 54° C.±2° C. for 14 days as the default test conditions.

The “ambient sample” is the sample at the room temperature which is before subjecting to the accelerated storage test.

The “accelerated storage sample” is the sample after subjecting the sample to accelerated storage tests at 54±2° C. for 14 days.

The ambient samples of the oil dispersion (OD) formulation of the above Example 1 were subjected to the accelerated storage test to find out the product stability.

Table 2 shows the physical and chemical properties of the oil-dispersion (OD) formulation of Example 1 before and after the accelerated storage test.

TABLE 2
Physical and chemical properties of the OD formulation of
Example 1 before and after the accelerated storage test.

| | | | | | Accelerated |
|---|---|---|---|---|---|
| | | | | | storage sample |
| | | | | Ambient | tested @ 54 ± 2° |
| S. | | | Product | sample | c. for 14 days |
| No. | Tests | | specifications | (before) | (after) |
| 1 | Appearance | | Off white to cream | Complies | Complies |
| | | | colour suspension | | |
| 2 | Active Ingredient/ | Chlorantraniliprole | Content: 5.70-6.60 | 6.00 | 5.96 (0.66%*) |
| 3 | content test % w/w | Acetamiprid | Content: 3.80-4.40 | 4.00 | 3.99 (0.25%*) |
| 4 | | Lambda cyhalothrin | Content: 4.75-5.50 | 5.00 | 4.98 (0.4%*) |

| 5 | Persistent Foam, mL | Max. 60 | | 15 | 14 |
|---|---|---|---|---|---|
| 6 | Wet sieve passing through | Min. 98.0 | | 99.94 | 99.95 |
| | 75 micron % w/w | | | | |
| 7 | pH of 1% aq. dispersion | 5.0-8.0 | | 6.14 | 6.18 |
| | | Time hr. | Limits of stability | | |
| 8 | Dispersion stability | 0 | Initial dispersion | Complies | Complies |
| | | | completed | | |

| | | | |
|---|---|---|---|
| 0.5 | No Cream and no | Nil | Nil |
| | sedimentation seen | | |
| | after 0.5 hours | | |
| | (creaming and | | |
| | sedimentation | | |
| | should not be more | | |
| | than 2 ml in 100 | | |
| | ml dilution). | | |
| 24.0 | Re-dispersion | Complies | Complies |
| | completed | | |
| 24.5 | No Cream and no | Nil | Nil |
| | sedimentation seen | | |
| | after 24.5 hours | | |
| | (creaming and | | |
| | sedimentation | | |
| | should not be more | | |
| | than 2 ml in 100 | | |
| | ml dilution). | | |

| | | | | |
|---|---|---|---|---|
| 9 | Particle size distribution, μ d(90) | Max. 12μ | 8.07 | 9.10 |
| 10 | Pourability % w/w as rinse residue | Max. 1.0 | 0.52 | 0.51 |

Min. = Minimum
Max. = Maximum

The results in Table 2 show that the appearance of the ambient sample of the oil-dispersion (OD) formulation before and after the accelerated storage test (@54±2° C. for 14 days) remained the same that is off white to cream colour suspension.

Further, the content of chlorantraniliprole, acetamiprid and lambda-cyhalothrin was found to be 6.00% w/w, 4.00% w/w, 5.00% w/w, respectively before subjecting the ambient sample to the accelerated storage test. After subjecting the ambient sample to the accelerated storage test the content of chlorantraniliprole, acetamiprid and lambda-cyhalothrin was found to be almost same, that is 5.96% w/w, 3.99% w/w, 4.98% w/w respectively. It indicates that the content of chlorantraniliprole, acetamiprid and lambda-cyhalothrin was degraded only by 0.66%, 0.25% and 0.4% respectively and falls within the product specification range and hence the content of the active ingredients in the formulation is stable.

The pH of the ambient sample of the OD formulation before subjecting it to the accelerated storage test was found to be 6.14. However, even after subjecting the ambient sample to the accelerated storage test the pH was found to be almost same, that is 6.18. It indicates that the oil-dispersion was adhering to the pH range of 5.0-8.0 which indicates that the formulation is stable.

Dispersion stability test is performed to ensure that a sufficient proportion of active ingredient is homogeneously dispersed in the spray liquid to give a satisfactory and effective mixture throughout spraying. The ambient sample and accelerated storage sample of the oil-dispersion (OD) formulation, subjected to dispersion stability test did not show any cream or sedimentation even after 0.5 hours of the dispersion or 24.5 hours of the re-dispersion test.

Tests such as persistent foam and pourability were conducted for the ambient sample of the oil-dispersion (OD) formulation, before and after accelerated storage test. The results indicated that persistent foam test showed low persistent foam of 15 ml and 14 ml indicating the less froth formation and pourability test showed low rinse residue of 0.52% and 0.51% indicating less wastage of the formulation.

The ambient sample of the oil-dispersion (OD) formulation was diluted in water and was tested for its particle size by particle size distribution test by using laser diffraction method using Malvern MS3000 and wet sieve passing test by using 75μ wet sieve. The particle size distribution test showed that particle size distribution of the ambient sample was d (90) is 8.07μ and the particle size distribution of the accelerated storage sample was found to be almost same that is d (90) is 9.10μ and wet sieve passing test showed passing of 99.94% w/w and 99.95% w/w of particles of the formulation through the 75μ wet sieve indicating the low particle size (9.10μ) of the formulation. Therefore, both the tests confirm the low particle size (9.10μ) and no crystal growth after the accelerated storage test.

The particle size distribution of the oil-dispersion (OD) is directly related to the efficacy, dispersion stability, and required dosage of the combination. That is the smaller particle size (9.10μ) of the oil-dispersion (OD) of the present invention provide better dispersion stability, since small particle sizes enable the Brownian motion to dominate over gravitational force, provides a larger specific surface area, which will further increase the dissolution rate, adhesion, and penetrability to the target pest, improving the efficacy and bioavailability of the formulation which leads to the increased insecticidal activity.

Thus, in all the tests, values of the tests remained almost same before and after accelerated storage test which indicates that the formulation is stable.

In view of the above test results, oil-dispersion (OD) formulation of the present invention prepared in accordance with the above examples are extrapolated to be stable for 2 years.

The advantages of the oil-dispersion (OD) compositions of the present invention include storage stability, excellent adherence to its target pest and easy penetration of active ingredients in the target pest, uniform spreading of spray solution over insects which leads to high absorption through insect cuticle, reduced sedimentation during storage, environmental friendly due to the usage of low cost and biodegradable solvents, simple production process saves production and equipment costs, simple and easy handling for the users as the dilution is made with the desired amount of water. Also, as the OD formulation is diluted in water, it forms a stable milky dispersion of fine particles size of from 0.1 to 12 microns which lead to the improved bio-efficacy.

### Example 4: Field Tests

The oil-dispersion (OD) of Example 1 was tested for its biological activity and the results are shown in Tables 3 to 6 below:

TABLE 3
Field test results of the chlorantraniliprole + acetamiprid + lambda-cyhalothrin oil-dispersion
(OD) applied against thrips in cotton at the Dehgam, Gujarat location in the Kharif season 2021.

| | | | | Mean no. of | | |
|---|---|---|---|---|---|---|
| | | | | thrips/leaf | | |
| | | Dosage | | (DAA) | | % Reduction |
| | | | Formulation | | 16 | over UTC |
| Types | Treatment | g a.i./ha | (g/ml/ha) | Before | DAA | (16 DAA) |
| Example 1 | Chlorantraniliprole | 30 + 25 + 20 | 500 | 146.8 | 12.3 | 93.76 |
| | 6% + Acetamiprid | | | | | |
| | 4% + Lambda | | | | | |
| | cyhalothrin 5% + | | | | | |
| | OD | | | | | |
| | (recommended | | | | | |
| | dosage) | | | | | |
| | Chlorantraniliprole | 10.45 + 23.75 + 19 | 475 | 146.8 | 13.5 | 93.15 |
| | 6% + Acetamiprid | | | | | |
| | 4% + Lambda | | | | | |
| | cyhalothrin 5% + | | | | | |
| | OD | | | | | |
| | (5% reduced | | | | | |
| | recommended | | | | | |
| | dosage) | | | | | |
| | Chlorantraniliprole | 9.9 + 22.5 + 18 | 450 | 151.0 | 15.8 | 91.99 |
| | 6% + Acetamiprid | | | | | |
| | 4% + Lambda | | | | | |
| | cyhalothrin 5% + | | | | | |
| | OD | | | | | |
| | (10% reduced | | | | | |
| | recommended | | | | | |
| | dosage) | | | | | |
| Individual | Chlorantraniliprole | 20 | 150 | 153.8 | 199.0 | 0 |
| ingredients | 20% SC | | | | | |
| | Lambda cyhalothrin | 25 | 500 | 146.8 | 88.2 | 55.29 |
| | 5% EC | | | | | |
| | Acetamiprid 20% SP | 20 | 100 | 149.4 | 110.1 | 44.19 |
| Conventional | Diafenthiuron | 250.63 + 24.38 | 625 | 151.8 | 95.1 | 51.79 |
| Combinations | 40.1% + | | | | | |
| | Acetamiprid | | | | | |
| | 3.9% WP | | | | | |
| | Chlorantraniliprole | 18.6 + 9.2 | 200 | 149.4 | 91.2 | 53.77 |
| | 9.3% + Lambda | | | | | |
| | cyhalothrin 4.6% | | | | | |
| | ZC | | | | | |
| | Acetamiprid 1.1% + | 11 + 55 | 1000 | 148.3 | 98.2 | 50.22 |
| | Cypermethrin | | | | | |
| | 5.50% EC | | | | | |
| Untreated | | — | — | 146.4 | 197.3 | 0 |
| check | | | | | | |

DAA—Days after application

As seen from the above results, 16 days after application of the OD formulation of the insecticide composition comprising chlorantraniliprole in an amount of 6%, acetamiprid in an amount of 4% and lambda-cyhalothrin in an amount of 5% at the application rate of 500, 475 and 450 g/ml per hectare (g/ml/ha), the thrips population was reduced to the greater extent that is 93.76%, 93.15% and 91.99 percent reduction of the thrips respectively in comparison to the untreated check.

The results were better in comparison to the individual compounds chlorantraniliprole, acetamiprid and lambda-cyhalothrin. That is the registered formulation of chlorantraniliprole 20% SC alone at the application rate of 150 g/ml per hectare showed 0% reduction against thrips. And the registered formulation of lambda cyhalothrin 5% EC alone at the application rate of 500 g/ml per hectare showed only 55.29% reduction of the thrips. Likewise, the registered formulation of acetamiprid 20% SP alone at the application rate of 100 g/ml per hectare showed only 44.19% reduction of the thrips.

Further, the results exhibited by the OD formulation of the present invention was better in comparison to the conventional combinations and formulations available in the market such as diafenthiuron 40.1%+acetamiprid 3.9% WP, chlorantraniliprole 9.3%+lambda cyhalothrin 4.6% ZC and acetamiprid 1.1%+cypermethrin 5.50% EC. That is diafenthiuron 40.1%+acetamiprid 3.9% WP, at the higher application rate of 625 g/ml per hectare showed only 51.79% reduction of the thrips which is 41.97% lesser than the thrips reduction of the present invention (93.76%). Further, chlorantraniliprole 9.3%+lambda cyhalothrin 4.6% ZC at the application rate of 200 g/ml per hectare showed only 53.77% reduction of the thrips which is 39.99% lesser than the thrips reduction of the present invention (93.76%). Similarly, acetamiprid 1.1%+cypermethrin 5.50% EC at the higher application rate of 1000 g/ml per hectare showed only 50.22% reduction of the thrips which is 43.54% lesser than the thrips reduction of the present invention (93.76%).

Additionally, the results of following Tables 4, 5 and 6 show that the compositions comprising chlorantraniliprole, acetamiprid and lambda-cyhalothrin formulated into OD resulted in greater than 89% reduction of jassids, and 88% reduction of pink bollworm, also 100% reduction of Spodoptera litura in comparison to the untreated check. Also, the percentage reduction of jassids, pink bollworm and Spodoptera litura by the present composition is higher than the individual compounds as well as conventional combinations.

TABLE 4
Field test results of the chlorantraniliprole + acetamiprid + lambda-cyhalothrin oil-dispersion
(OD) applied against Jassids in cotton at the Dehgam, Gujarat location in the Kharif season 2021.

| | | | | Mean no. of | | |
|---|---|---|---|---|---|---|
| | | | | jassids/leaf | | |
| | | Dosage | | (DAA) | | % Reduction |
| | | | Formulation | | 16 | over UTC |
| Types | Treatment | g a.i./ha | (g/ml/ha) | Before | DAA | (16 DAA) |
| Example 1 | Chlorantraniliprole | 30 + 25 + 20 | 500 | 3.7 | 1.7 | 89.69 |
| | 6% + Acetamiprid | | | | | |
| | 4% + Lambda | | | | | |
| | cyhalothrin 5% + | | | | | |
| | OD | | | | | |
| | (recommended | | | | | |
| | dosage) | | | | | |
| | Chlorantraniliprole | 10.45 + 23.75 + 19 | 475 | 5 | 2.6 | 84.24 |
| | 6% + Acetamiprid | | | | | |
| | 4% + Lambda | | | | | |
| | cyhalothrin 5% + | | | | | |
| | OD | | | | | |
| | (5% reduced | | | | | |
| | recommended | | | | | |
| | dosage) | | | | | |
| | Chlorantraniliprole | 9.9 + 22.5 + 18 | 450 | 5.3 | 3.7 | 77.57 |
| | 6% + Acetamiprid | | | | | |
| | 4% + Lambda | | | | | |
| | cyhalothrin 5% + | | | | | |
| | OD | | | | | |
| | (10% reduced | | | | | |
| | recommended | | | | | |
| | dosage) | | | | | |
| Individual | Chlorantraniliprole | 20 | 150 | 6.7 | 16.9 | 0 |
| ingredients | 20% SC | | | | | |
| | Lambda cyhalothrin | 25 | 500 | 7.5 | 9.3 | 43.46 |
| | 5% EC | | | | | |
| | Acetamiprid 20% SP | 20 | 100 | 6.4 | 7.4 | 55.15 |
| Conventional | Diafenthiuron 40.1% + | 250.63 + 24.38 | 625 | 5.1 | 6.9 | 58.18 |
| Combinations | Acetamiprid | | | | | |
| | 3.9% WP | | | | | |
| | Chlorantraniliprole | 18.6 + 9.2 | 200 | 5.7 | 7.5 | 54.54 |
| | 9.3% + Lambda | | | | | |
| | cyhalothrin 4.6% ZC | | | | | |
| | Acetamiprid 1.1% + | 11 + 55 | 1000 | 7.1 | 8.3 | 49.69 |
| | Cypermethrin 5.50% | | | | | |
| | EC | | | | | |
| Untreated | | — | — | 6.5 | 16.5 | 0 |
| check | | | | | | |

DAA—Days after application

TABLE 5
Field test results of the chlorantraniliprole + acetamiprid + lambda-cyhalothrin oil-dispersion
(OD) applied against Pink bollworm in cotton at the Dehgam, Gujarat location in the Kharif season 2021.

| | | | | Mean pink | % |
|---|---|---|---|---|---|
| | | Dosage | | damaged bolls/50 | Reduction |
| | | | Formulation | boll/10 plants | over UTC |
| Types | Treatment | g a.i./ha | (g/ml/ha) | 9 DAA | (9 DAA) |
| Example 1 | Chlorantraniliprole | 30 + | 500 | 1.3 | 88.03 |
| | 6% + Acetamiprid 4% + | 25 + 20 | | | |
| | Lambda cyhalothrin 5% + | | | | |
| | OD (recommended dosage) | | | | |
| | Chlorantraniliprole | 28.5 + | 475 | 2.0 | 81.69 |
| | 6% + Acetamiprid 4% + | 23.75 + 19 | | | |
| | Lambda cyhalothrin 5% + | | | | |
| | OD (5% reduced | | | | |
| | recommended dosage) | | | | |
| | Chlorantraniliprole | 27.0 + | 450 | 2.6 | 76.14 |
| | 6% + Acetamiprid 4% + | 22.5 + 18 | | | |
| | Lambda cyhalothrin 5% + | | | | |
| | OD (10% reduced | | | | |
| | recommended dosage) | | | | |
| Individual | Chlorantraniliprole | 30 | 150 | 9.6 | 11.92 |
| ingredients | 20% SC | | | | |
| | Lambda cyhalothrin | 25 | 500 | 6.6 | 39.44 |
| | 5% EC | | | | |
| | Acetamiprid 20% SP | 20 | 100 | 9.9 | 9.17 |
| Conventional | Chlorantraniliprole | 18.6 + 9.2 | 200 | 3.3 | 69.72 |
| Combinations | 9.3% + Lambda | | | | |
| | cyhalothrin 4.6% ZC | | | | |
| | Acetamiprid 1.1% + | 11 + 55 | 1000 | 7.4 | 32.11 |
| | Cypermethrin 5.50% EC | | | | |
| Untreated | | — | — | 10.9 | — |
| check | | | | | |

DAA—Days after application

TABLE 6
Field test results of the chlorantraniliprole + acetamiprid + lambda-cyhalothrin oil-dispersion
(OD) applied against spodoptera litura in cotton at the Guntur, Andhra Pradesh location in the Kharif season 2021.

| | | | | Mean no. of | | |
|---|---|---|---|---|---|---|
| | | | | spodoptera | | |
| | | Dosage | | larvae/leaf (15 DAA) | | % Reduction |
| | | | Formulation | | 15 | over UTC |
| Types | Treatment | g a.i./ha | (g/ml/ha) | Before | DAA | (15 DAA) |
| Example 1 | Chlorantraniliprole | 30 + 25 + 20 | 500 | 1.73 | 0 | 100 |
| | 6% + Acetamiprid 4% + | | | | | |
| | Lambda cyhalothrin | | | | | |
| | 5% + OD | | | | | |
| | (recommended | | | | | |
| | dosage) | | | | | |
| | Chlorantraniliprole | 28.5 + 23.75 + 19 | 475 | 1.67 | 0.2 | 95.08 |
| | 6% + Acetamiprid 4% + | | | | | |
| | Lambda | | | | | |
| | Cyhalothrin 5% + | | | | | |
| | OD | | | | | |
| | (5% reduced | | | | | |
| | recommended | | | | | |
| | dosage) | | | | | |
| | Chlorantraniliprole | 27.0 + 22.5 + 18 | 450 | 1.27 | 0.4 | 90.17 |
| | 6% + Acetamiprid 4% + | | | | | |
| | Lambda cyhalothrin | | | | | |
| | 5% + OD | | | | | |
| | (10% reduced | | | | | |
| | recommended | | | | | |
| | dosage) | | | | | |
| Individual | Chlorantraniliprole | 30 | 150 | 2.33 | 0.6 | 85.25 |
| ingredients | 18.5% SC | | | | | |
| | Lambda cyhalothrin | 25 | 500 | 1.40 | 1.25 | 69.28 |
| | 5% EC | | | | | |
| | Acetamiprid 20% SP | 20 | 100 | 1.13 | 4.47 | 0 |
| Conventional | Thiamethoxam | 27.9 + 14.25 | 150 | 1.40 | 1.00 | 75.42 |
| Combinations | 12.60% + Lambda | | | | | |
| | cyhalothrin 09.50% | | | | | |
| | ZC | | | | | |
| | Acetamiprid 1.1% + | 11 + 55 | 1000 | 1.07 | 2.13 | 47.54 |
| | Cypermethrin 5.50% | | | | | |
| | EC | | | | | |
| | Chlorantraniliprole | 25 | 125 | 1.00 | 1.00 | 75.41 |
| | 18.5% SC | | | | | |
| Untreated | | — | — | 1.40 | 4.07 | 0 |
| check | | | | | | |

DAA—Days after application

Accordingly, the above test results show unexpected and surprising results proving the synergistic effect of the combination of chlorantraniliprole, acetamiprid and lambda-cyhalothrin in control of thrips, jassids, pink bollworm and Spodoptera litura in the cotton fields. As can be seen from Tables 3 to 6, the combined administration of chlorantraniliprole, acetamiprid and lambda-cyhalothrin resulted in significant reduction in insect population as compared to single administration of the individual insecticides. It is also evident that the combination in accordance with the present invention exhibits a superior insecticidal effect as compared to other known registered insecticide combination products available in the market.

The foregoing examples are merely illustrative and are not to be taken as limitations upon the scope of the invention. Various changes and modifications to the disclosed examples will be apparent to those skilled in the art. Such changes and modifications may be made without departing from the scope of the invention.

We claim:

1. An insecticide composition comprising the active ingredients chlorantraniliprole, acetamiprid and lambda-cyhalothrin.

2. The insecticide composition as claimed in claim 1, wherein the composition comprises one or more agrochemically acceptable excipient(s).

3. The insecticide composition as claimed in claim 2, wherein excipients are selected from the group comprising of an emulsifier, a dispersing agent, a stabilizing agent, a wetting agent, a spreading agent, an anti-foaming agent, a rheology modifier, a solvent, a pH modifier, a co-solvent, an inert carrier, an anti-caking agent, an antioxidant, a biocide, an anti-freezing agent, an anti crystalline agent or combination thereof.

4. The insecticide composition as claimed in claim 1, wherein the composition comprises chlorantraniliprole in an amount of from 0.1% to 30% w/w, acetamiprid in an amount of from 0.1% to 25% w/w and lambda-cyhalothrin in an amount of from 0.1% to 25% w/w.

5. An insecticide formulation comprising the active ingredients chlorantraniliprole, acetamiprid, lambda-cyhalothrin and one or more agrochemically acceptable excipient(s).

6. The insecticide formulation as claimed in claim 5, wherein excipients are selected from the group comprising of an emulsifier, a dispersing agent, a stabilizing agent, a wetting agent, a spreading agent, an anti-foaming agent, a rheology modifier, a solvent, a pH modifier, a co-solvent, an inert carrier, an anti-caking agent, an antioxidant, a biocide, an anti-freezing agent, an anti crystalline agent or combination thereof.

7. The insecticide formulation as claimed in claim 5, wherein the formulation comprises chlorantraniliprole in an amount of from 0.1% to 30% w/w, acetamiprid in an amount of from 0.1% to 25% w/w and lambda-cyhalothrin in an amount of from 0.1% to 25% w/w.

8. The insecticide formulation as claimed in claim 5, wherein the formulation is selected from water-dispersible granule (WDG), a water-soluble granule (SG), a wettable powder (WP), a water-dispersible powder (WDP), a water-soluble powder (SP), a granule (GR), an encapsulated granule (CG), a fine granule (FG), a macrogranule (GG), a microgranule (MG), a suspension concentrate (SC), a water-soluble concentrate (SL), an emulsifiable concentrate (EC), an emulsion (EW), a micro-emulsion (ME), a flowable suspension (FS), a suspoemulsion (SE), ZC formulation (ZC), soil applied granules (SAG), dustable powder (DP), a gel, a water-dispersible tablet (WT), an oil-dispersion (OD), a dispersible concentrate (DC) or a microencapsulated suspension (CS).

9. The insecticide formulation as claimed in claim 8, wherein the formulation is an oil-dispersion (OD).

10. The insecticide formulation as claimed in claim 9, wherein the oil-dispersion (OD) formulation comprises:
a) 0.1% to 30.0% chlorantraniliprole by weight of the formulation;
b) 0.1% to 25.0% acetamiprid by weight of the formulation;
c) 0.1% to 25.0% lambda-cyhalothrin by weight of the formulation;
d) 0.1% to 15.0% emulsifier by weight of the formulation;
e) 0.01% to 12.0% dispersing agent by weight of the formulation;
f) 0.01% to 5.0% stabilizing agent by weight of the formulation;
g) 0.01% to 9.0% wetting agent by weight of the formulation;
h) 0.1% to 20.0% spreading agent by weight of the formulation;
i) 0.01% to 5.0% antifoaming agent by weight of the formulation;
j) 0.01% to 12.0% rheology modifier by weight of the formulation; and
k) 1.0% to 95.0% solvent by weight of the formulation.

11. The insecticide formulation as claimed in claim 10, wherein the oil-dispersion (OD) comprises:
a) 0.1% to 30.0% chlorantraniliprole by weight of the formulation
b) 0.1% to 25.0% acetamiprid by weight of the formulation;
c) 0.1% to 25.0% lambda-cyhalothrin by weight of the formulation;
d) 0.1% to 15.0% emulsifier by weight of the formulation selected from the group comprising of ethoxylated propoxylated alcohols, alkylphenolethoxylates, alkoxylated tristyrylphenols, ethoxylated propoxylated polyaryl phenol, ethoxylated fatty acids, ethoxylated ricinoleic acid triglycerides, castor oil ethoxylate or mixtures thereof;
e) 0.01% to 12.0% dispersing agent by weight of the formulation selected from the group comprising of naphthalene formaldehyde condensates, polycarboxylates, calcium dodecylbenzene sulfonate, polystyrenated acrylated co-polymer, salts of phenol sulfonic acids, random co-polymer of alcoxylated polyethylene glycol or mixtures thereof;
f) 0.01% to 5.0% stabilizing agent by weight of the formulation selected from the group comprising of precipitated silica, polyvinylpyrrolidone (PVP) or mixtures thereof;
g) 0.01% to 9.0% wetting agent by weight of the formulation selected from the group comprising of sodium alkyl naphthalene sulfonate, alpha olefin sulfonates, disodium laureth sulfosuccinate, diisodecyl sodium sulfosuccinate, alkyl sulfosuccinic monoesters, dioctyl sulfosuccinate sodium salt or mixtures thereof;
h) 0.1% to 20.0% spreading agent by weight of the formulation selected from the group comprising of polyoxyethylene alkyl ether, trisiloxane ethoxylate, polysorbates, sodium lauryl sulphate, tridecyl alcohol ethoxylate or mixtures thereof;
i) 0.01% to 5.0% antifoaming agent by weight of the formulation selected from the group comprising perfluroalkylphosphonic acids, polydimethyl siloxane or mixtures thereof;
j) 0.01% to 12.0% rheology modifier by weight of the formulation selected from the group comprising of fume silica, bentonite, hydroxymethyl cellulose, xanthan gum, thickening silica, hydrated clay minerals, magnesium aluminium silicates, organic derivative of hectorite clay, hydrophobic fumed silica or mixture thereof; and
k) 1.0% to 95.0% solvent by weight of the formulation selected from the group comprising of N-alkyl-pyrrolidone, oil medium selected from the group comprising, esterified fatty acids selected from methyl ester of triglycerides containing C₁₂-C₂₂ saturated and unsaturated fatty acids, ethyl ester of triglycerides containing C₁₂-C₂₂ saturated and unsaturated fatty acids such as methyl soyate, ethyl soyate, rapeseed methyl ester, rapeseed ethyl ester or mixtures thereof.

12. A process for preparing the oil-dispersion (OD) as claimed in claim 5, the process comprises,
a) mixing one or more excipient(s) along with an oil medium to obtain a mixture;
b) adding chlorantraniliprole, acetamiprid and lambda-cyhalothrin to the mixture and continuing to mix to obtain a slurry;
c) subjecting the slurry for particle size reduction by passing the slurry through a mill to obtain a milled slurry; and
d) adding a rheology modifier to the milled slurry and continuing to mix to obtain a homogeneous oil dispersion (OD).

13. The process for preparing the oil-dispersion (OD) as claimed in claim 12, wherein excipients are selected from the group comprising of an emulsifier, a dispersing agent, a stabilizing agent, a wetting agent, a spreading agent, an anti-foaming agent, a rheology modifier, a solvent or combination thereof.
